(19) United States
(12) Patent Application Publication
(10) Pub. No.: US 2020/0106329 A1
(43) Pub. Date: Apr. 2, 2020

(54) MOTOR UNIT AND ELECTRIC PUMP DEVICE

(71) Applicant: NIDEC TOSOK CORPORATION, Kanagawa (JP)

(72) Inventors: Yoshiyuki KOBAYASHI, Kanagawa (JP); Tatsuo ABE, Kanagawa (JP); Hitoshi SAKAMOTO, Kanagawa (JP)

(73) Assignee: NIDEC TOSOK CORPORATION, Kanagawa (JP)

(21) Appl. No.: 16/581,764

(22) Filed: Sep. 25, 2019

(30) Foreign Application Priority Data
Sep. 28, 2018 (JP) 2018-185675

(51) Int. Cl. H02K 5/22; F04B 17/03; H02K 1/27; H02P 27/04; F04C 15/00

(52) U.S. Cl. CPC H02K 5/225; F04B 17/03; F04C 2210/206; H02P 27/04; F04C 15/0003; H02K 1/2706

(57) ABSTRACT

One aspect of the motor unit of the disclosure includes a motor, an inverter substrate electrically connected to the motor, a housing configured to accommodate the motor and the inverter substrate, a terminal located at an end portion of a wiring member which extends over an outside and an inside of the housing, and inserted into a terminal insertion hole which passes through the inverter substrate, a screw member inserted into a screw insertion hole which passes through the inverter substrate and configured to fix the inverter substrate to the housing or the motor, and a substrate positioning structure configured to position the inverter substrate with respect to the housing.

### CROSS-REFERENCE TO RELATED APPLICATION

This application claims the priority of Japan patent application serial no. 2018-185675, filed on Sep. 28, 2018. The entirety of the above-mentioned patent application is hereby incorporated by reference herein and made a part of this specification.

### BACKGROUND

### Technical Field

The disclosure relates to a motor unit and an electric pump device.

### Description of Related Art

An electric pump device includes a pump, a motor, a housing, and a substrate. In an electric pump device of Japanese Laid-Open No. 5994638, a circuit board is fastened to a pedestal part of an insulator by a plurality of screws.

A case in which a terminal of a wiring member is inserted into a through hole provided in a substrate and then soldered may be considered. In this case, in the configuration of Japanese Patent No. 5994638, when the first screw is fastened, the substrate rotates with the screw and a bending load may be applied to the terminal or a load may be applied to solder.

### SUMMARY

In view of the above-described circumstances, the disclosure provides a motor unit and an electric pump device which is able to prevent an inverter substrate from rotating with a screw member and to minimize a load applied to a terminal or solder.

According to an aspect of the disclosure, there is provided a motor unit including a motor, an inverter substrate electrically connected to the motor, a housing configured to accommodate the motor and the inverter substrate, a terminal located at an end portion of a wiring member which extends over an outside and an inside of the housing, and inserted into a terminal insertion hole which passes through the inverter substrate, a screw member inserted into a screw insertion hole which passes through the inverter substrate and configured to fix the inverter substrate to the housing or the motor, and a substrate positioning structure configured to position the inverter substrate with respect to the housing.

Further, according to an aspect of the disclosure, there is provided an electric pump device including the above-described motor unit.

According to the motor unit and the electric pump device of the aspects of the disclosure, it is possible to prevent an inverter substrate from rotating with a screw member and to minimize a load applied to a terminal or solder.

### BRIEF DESCRIPTION OF THE DRAWINGS

FIG. 1 is a perspective view showing a motor unit and an electric pump device according to an embodiment.

FIG. 2 is a front view showing the motor unit and the electric pump device according to the embodiment.

FIG. 3 is a longitudinal sectional view taken along line III-III in FIG. 2.

FIG. 4 is a rear view (plan view) showing the motor unit and the electric pump device of the embodiment and shows a state in which a first member of an inverter housing part and the like are removed from the device.

FIG. 5 is an enlarged rear view showing a part of the motor unit and the electric pump device of the embodiment and shows a state in which the first member of the inverter housing part, an inverter substrate, and the like are removed from the device.

FIG. 6 is an enlarged perspective view showing a part of the motor unit and the electric pump device of the embodiment and shows a state in which the first member of the inverter housing part, the inverter substrate, and the like are removed from the device. FIG. 7 is a longitudinal sectional view taken along line VII-VII in FIG. 5.

FIG. 8 is a plan view showing a modified example of a substrate positioning structure.

### DESCRIPTION OF EMBODIMENTS

A motor unit 10 according to an embodiment of the disclosure and an electric pump device 1 including the motor unit 10 will be described with reference to the drawings. In the drawing, an XYZ coordinate system is appropriately shown as a three-dimensional orthogonal coordinate system. The motor unit 10 and the electric pump device 1 include a motor 20 and an inverter substrate 40. The motor 20 has a central axis J, and the central axis J extends in a Z-axis direction. In the following description, a direction parallel to the central axis J is simply referred to as “axial direction,” unless otherwise specified. A position of the motor 20 in the axial direction and a position of the inverter substrate 40 in the axial direction are different from each other. In the axial direction, a direction from the motor 20 toward the inverter substrate 40 is referred to as toward one side (the +Z side) in the axial direction, and a direction from the inverter substrate 40 toward the motor 20 is referred to as toward the other side (the −Z side) in the axial direction. A radial direction centered on the central axis J is simply referred to as a “radial direction”. In the radial direction, a direction of approach to the central axis J is referred to as radially inward, and a direction away from the central axis J is refer to as radially outward. A circumferential direction around the central axis J, that is, when turning around the central axis J is simply referred to as “circumferential direction.” In the embodiment, a “parallel direction” includes a substantially parallel direction, and an “orthogonal direction” includes a substantially orthogonal direction.

The electric pump device 1 of the embodiment suctions and discharges a fluid such as oil, for example. The electric pump device 1 has a function of circulating the fluid through a flow path, for example. When the fluid is an oil, the electric pump device 1 may be rephrased as an electric oil pump device. Although not particularly shown, the electric pump device 1 is provided, for example, in a driving device of a vehicle or the like. That is, the electric pump device 1 is mounted in a vehicle.

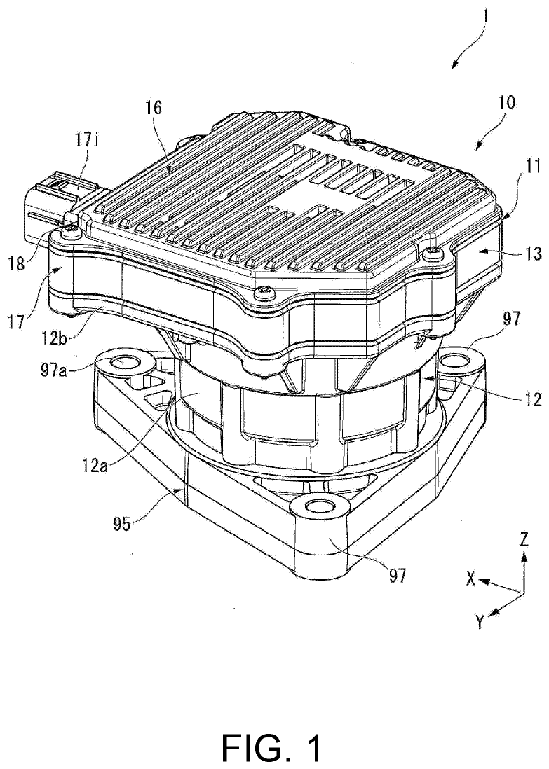

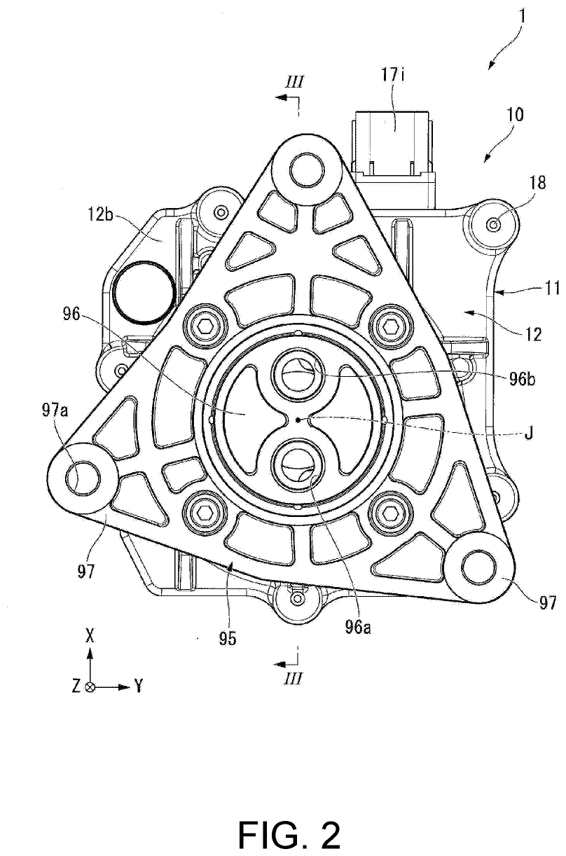

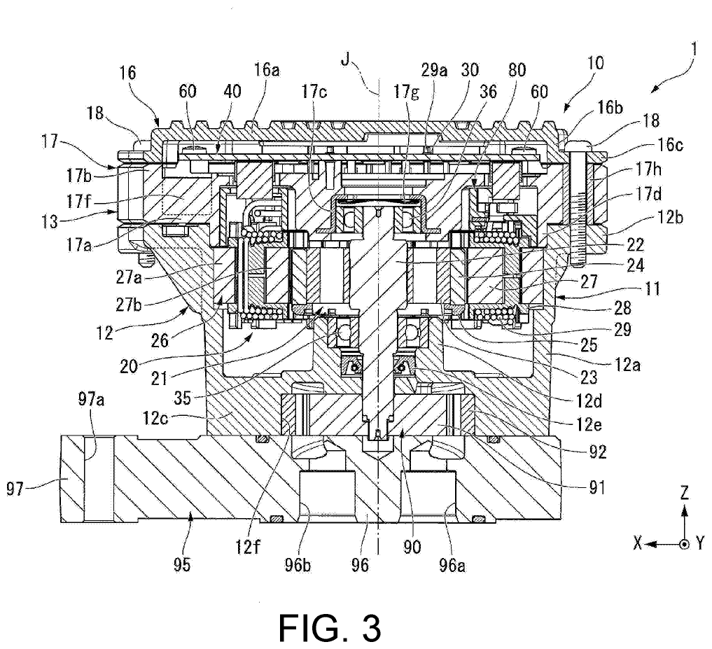

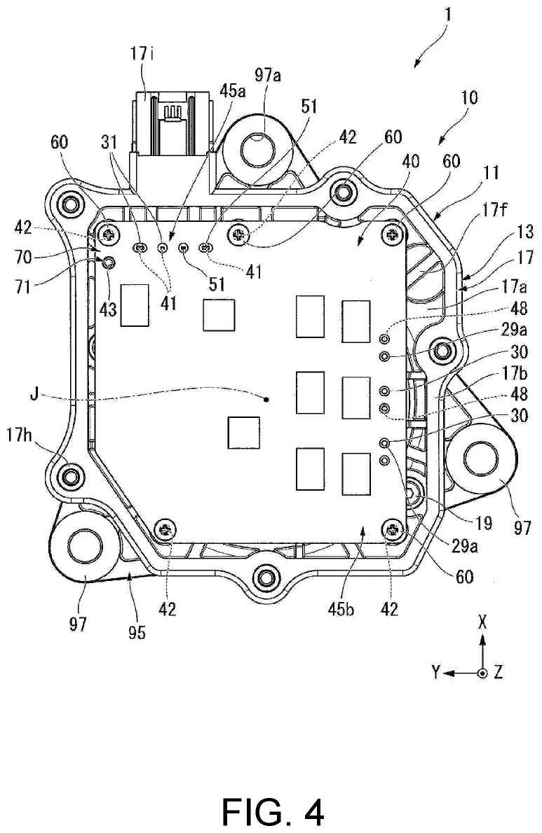

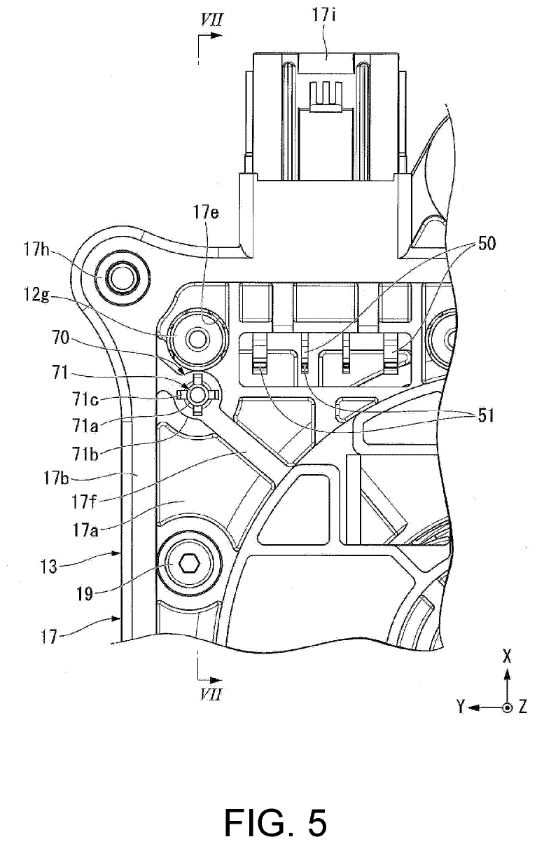

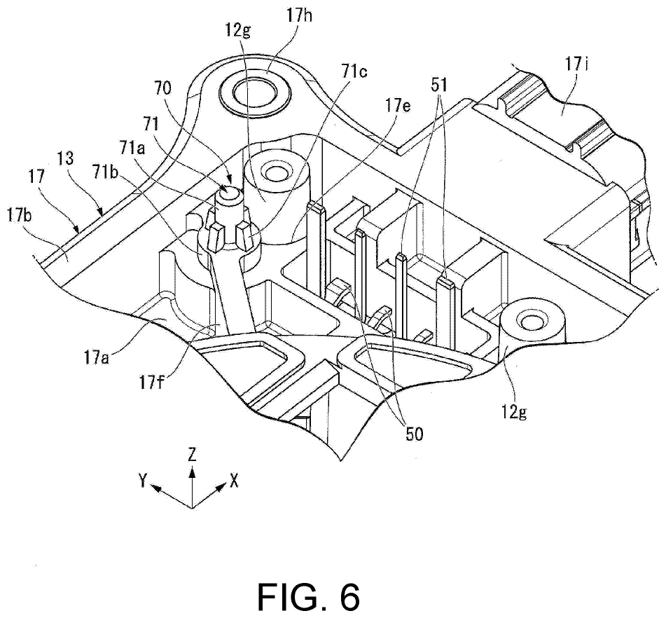

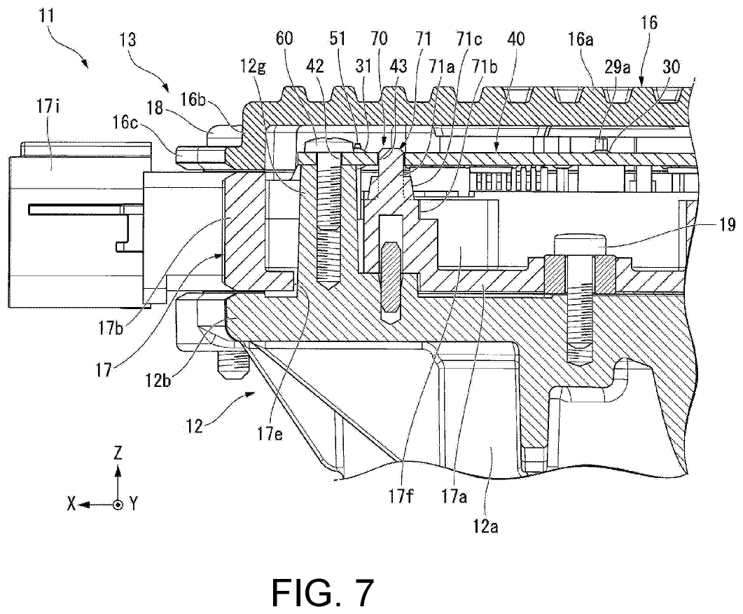

As shown in FIGS. 1 to 7, the motor unit 10 includes a housing 11, a fastening screw 18, a fixing screw 19, a motor 20, an inverter substrate 40, a wiring member 50, a screw member 60, a substrate positioning structure 70, and a coil support 80. The wiring member 50 has a terminal 51 located at an end portion of the wiring member 50. That is, the motor unit 10 includes the terminal 51. The electric pump device 1 includes the motor unit 10, a pump part 90, and a pump cover 95. That is, the electric pump device 1 includes the housing 11, the fastening screw 18, the fixing screw 19, the motor 20, the inverter substrate 40, the wiring member 50 and the terminal 51 thereof, the screw member 60, the substrate positioning structure 70, the coil support 80, the pump part 90, and the pump cover 95. In the embodiment, a pair of plate surfaces of the inverter substrate 40 faces the axial direction. One plate surface of the pair of plate surfaces of the inverter substrate 40 faces the one side in the axial direction. The other plate surface of the pair of plate surfaces of the inverter substrate 40 faces the other side in the axial direction. In the embodiment, the expression “seen in the axial direction” is synonymous with “in a plan view of the inverter substrate 40.”

The housing 11 accommodates the motor 20 and the inverter substrate 40. The housing 11 has a motor housing part 12 and an inverter housing part 13. The motor housing part 12 accommodates the motor 20. In the embodiment, the motor housing part 12 also accommodates the pump part 90. That is, the housing 11 also accommodates the pump part 90. The motor housing part 12 includes an accommodation tubular part 12a, a flange part 12b, a pump accommodation wall part 12c, a bearing holding tubular part 12d, an oil seal 12e, and a support column part 12g.

The accommodation tubular part 12a has a tubular shape which extends in the axial direction. In the embodiment, the accommodation tubular part 12a has a cylindrical shape. The motor 20 is accommodated in the accommodation tubular part 12a. The flange part 12b extends radially outward from an end portion of the accommodation tubular part 12a on the one side in the axial direction. The flange part 12b has a plate shape of which a plate surface faces the axial direction. In the embodiment, an external shape of the flange part 12b when seen in the axial direction is a substantially polygonal shape.

The pump accommodation wall part 12c is disposed at an end portion of the accommodation tubular part 12a on the other side in the axial direction. The pump accommodation wall part 12c is disposed in the accommodation tubular part 12a. The pump accommodation wall part 12c closes an opening of the accommodation tubular part 12a on the other side in the axial direction. The pump accommodation wall part 12c has a plate shape of which a plate surface faces the axial direction. In the embodiment, the pump accommodation wall part 12c has a substantially disk shape. The pump accommodation wall part 12c accommodates the pump part 90. The pump accommodation wall part 12c has a pump accommodation hole 12f and a plurality of lightening holes (not shown).

The pump accommodation hole 12f is recessed from the plate surface of the pump accommodation wall part 12c which faces the other side in the axial direction to the one side in the axial direction. In the embodiment, the pump accommodation hole 12f has a circular hole shape. The pump accommodation hole 12f is disposed at a center portion of the pump accommodation wall part 12c when seen in the axial direction. Although not particularly shown, the plurality of lightening holes is recessed from the plate surface of the pump accommodation wall part 12c which faces the one side in the axial direction to the other side in the axial direction and is disposed to be spaced apart from each other in the circumferential direction. The plurality of lightening holes is disposed outward from the pump accommodation hole 12f in the radial direction.

The bearing holding tubular part 12d has a tubular shape which extends from the pump accommodation wall part 12c to the one side in the axial direction. The bearing holding tubular part 12d protrudes from the plate surface of the pump accommodation wall part 12c which faces the one side in the axial direction to the one side in the axial direction. The bearing holding tubular part 12d holds a first bearing 35 of the motor 20 which will be described later. Among a plurality of bearings 35 and 36 which is disposed in the motor 20 to be spaced apart from each other in the axial direction, the first bearing 35 is a bearing located on the other side in the axial direction of a rotor core 23 which will be described later. The first bearing 35 is fitted into the bearing holding tubular part 12d. The oil seal 12e has an annular shape centered on the central axis J. The oil seal 12e is disposed in the bearing holding tubular part 12d and is located on the other side from the first bearing 35 in the axial direction.

The support column part 12g extends in the axial direction. The support column part 12g is disposed on the flange part 12b and extends from the flange part 12b to the one side in the axial direction. The support column part 12g protrudes from the plate surface of the flange part 12b which faces the one side in the axial direction to the one side in the axial direction. A plurality of support column parts 12g is provided. The plurality of support column parts 12g is disposed to be spaced apart from each other in the circumferential direction when seen in the axial direction. Specifically, when seen in the axial direction, that is, in the plan view of the inverter substrate 40, the plurality of support column parts 12g is disposed at positions overlapping an outer peripheral portion of the inverter substrate 40 and spaced apart from each other. The support column parts 12g are fixed to the inverter substrate 40.

In the embodiment, the support column part 12g is substantially cylindrical. The support column part 12g has an outer diameter which decreases toward the one side in the axial direction. An outer peripheral surface of the support column part 12g is tapered. The support column part 12g has a female screw part on an inner peripheral surface of the support column part 12g. An end surface of the support column part 12g which faces the one side in the axial direction is a plane perpendicular to the central axis J. The end surface of the support column part 12g which faces the one side in the axial direction is in contact with the plate surface of the inverter substrate 40 which faces the other side in the axial direction.

The support column part 12g is disposed in the inverter housing part 13. The support column part 12g extends inside the inverter housing part 13. The support column part 12g passes through a second member 17 (described later) of the inverter housing part 13. The support column part 12g passes through a bottom wall part 17a (described later) of the second member 17 in the axial direction. The support column part 12g is disposed inside a peripheral wall part 17b (described later) of the second member 17 when seen in the axial direction. The support column part 12g protrudes to the one side in the axial direction from the peripheral wall part 17b when seen in the radial direction.

The inverter housing part 13 accommodates the inverter substrate 40. In the embodiment, the inverter housing part 13 also accommodates the coil support 80. That is, the housing 11 also accommodates the coil support 80. The inverter housing part 13 includes a first member 16 and a second member 17.

The first member 16 may be rephrased as a lid member of the inverter housing part 13. The first member 16 is disposed on one side of the inverter substrate 40 in the axial direction and covers the inverter substrate 40 from the one side in the axial direction. The first member 16 faces one of the pair of plate surfaces of the inverter substrate 40. The first member 16 faces one plate surface of the inverter substrate 40 which faces the one side in the axial direction with a gap therebetween in the axial direction. The first member has a tubular shape with a top.

The first member 16 has a top wall 16a, a peripheral wall 16b, and a flange 16c. The top wall 16a faces one plate surface of the inverter substrate 40. The peripheral wall 16b has a tubular shape which extends from an outer peripheral portion of the top wall 16a to the other side in the axial direction. The peripheral wall 16b is disposed to overlap the inverter substrate 40 when seen in the radial direction. The flange 16c extends radially outward from the end portion of the peripheral wall 16b on the other side in the axial direction.

The second member 17 may be rephrased as a main body member of the inverter housing part 13. The second member 17 is located between the motor housing part 12 and the first member 16 in the axial direction. That is, the second member 17 is disposed between the motor housing part 12 and the first member 16. The second member 17 is fixed to the flange part 12b. The second member 17 is sandwiched between the flange part 12b and the flange 16c in the axial direction and is fixed by the fastening screw 18. A plurality of fastening screws 18 is provided. The plurality of fastening screws 18 is disposed to be spaced apart from each other in the circumferential direction.

The second member 17 is disposed on the other side of the inverter substrate 40 in the axial direction and covers the inverter substrate 40 from the other side in the axial direction. The second member 17 faces the other one of the pair of plate surfaces of the inverter substrate 40. The second member 17 faces the other plate surface of the inverter substrate 40 which faces the other side in the axial direction with a gap therebetween in the axial direction. The second member 17 has a tubular shape with a bottom.

The second member 17 has the bottom wall part 17a and the peripheral wall part 17b. The bottom wall part 17a faces the other plate surface of the inverter substrate 40. The bottom wall part 17a has a plate shape of which a plate surface faces the axial direction. The bottom wall part 17a is fixed to the flange part 12b by the fixing screw 19. That is, the second member 17 is fixed to the motor housing part 12 with the fixing screw 19. A plurality of fixing screws 19 is provided. The plurality of fixing screws 19 is disposed to be spaced apart from each other in the circumferential direction.

The bottom wall part 17a includes a bearing holder 17c, a wave washer 17g, a fitting tubular part 17d, a through hole 17e, a rib part 17f, and a pin part 71. That is, the second member 17 has the bearing holder 17c and the through hole 17e. Also, the pin part 71 is provided in the inverter housing part 13.

The bearing holder 17c is formed of a metal. When the second member 17 is injection-molded, the bearing holder 17c is disposed in a mold (not shown) together with another metal part. The second member 17 is insert-molded together with the bearing holder 17c by filling the mold with a molten resin and solidifying the molten resin. That is, the second member 17 has a resin part. The bearing holder 17c has a tubular shape with a top. The bearing holder 17c holds at least one bearing 36 among a plurality of bearings 35 and 36 (described later) of the motor 20. The bearing holder 17c holds the second bearing 36. The second bearing 36 is a bearing located on one side of the rotor core 23 (described later) in the axial direction among the plurality of bearings 35 and 36. The second bearing 36 is fitted into the bearing holder 17c.

The wave washer 17g has an annular shape centered on the central axis J. The wave washer 17g is disposed in the bearing holder 17c and is located between a top wall part of the bearing holder 17c and the second bearing 36 in the axial direction. The wave washer 17g is in contact with the top wall part of the bearing holder 17c and the second bearing 36 in the axial direction.

The fitting tubular part 17d has a tubular shape which extends from the bottom wall part 17a to the other side in the axial direction. The fitting tubular part 17d is fitted into the accommodation tubular part 12a. In the embodiment, the fitting tubular part 17d has a cylindrical shape and is fitted inside an end portion (an opening part) of the accommodation tubular part 12a on the one side in the axial direction.

The through hole 17e passes through the bottom wall part 17a in the axial direction. In the embodiment, the through hole 17e has a circular hole shape. A plurality of through holes 17e is provided. The plurality of through holes 17e is disposed to be spaced apart from each other in the circumferential direction when seen in the axial direction. Specifically, when seen in the axial direction, that is, in the plan view of the inverter substrate 40, the plurality of through holes 17e is disposed at positions overlapping the outer peripheral portion of the inverter substrate 40 to be spaced apart from each other. The support column parts 12g are respectively inserted into the through holes 17e. That is, each of the support column parts 12g is inserted into each of the through holes 17e.

The rib part 17f protrudes from a plate surface of the bottom wall part 17a which faces the one side in the axial direction to the one side in the axial direction and extends along a virtual plane (not shown) perpendicular to the central axis J. A plurality of rib parts 17f is provided. The plurality of rib parts 17f extends radially around the central axis J. In the embodiment, the plurality of rib parts 17f includes a rib part 17f which extends in the radial direction and a rib part 17f which extends in a direction other than the radial direction when seen in the axial direction. The plurality of rib part 17f is disposed to be spaced apart from each other in the circumferential direction. Outer end portions of the rib parts 17f in the radial direction are connected to the peripheral wall part 17b. End surfaces of the rib parts 17f which face the one side in the axial direction are located on the other side in the axial direction from an end surface of the peripheral wall part 17b which faces the one side in the axial direction.

The pin part 71 extends in the axial direction. The pin part 71 extends from the bottom wall part 17a to the one side in the axial direction. In the embodiment, the pin part 71 is provided integrally with one rib part 17f among the plurality of rib parts 17f. That is, the pin part 71 and the one rib part 17f are portions of a single member. The pin part 71 is located between a radially inner end portion and a radially outer end portion of the one rib part 17f.

The pin part 71 is inserted into a positioning hole part 43 (described later) of the inverter substrate 40. An end portion of the pin part 71 on the one side in the axial direction is inserted into the positioning hole part 43. The end portion of the pin part 71 on the one side in the axial direction protrudes to the one side in the axial direction from the end surface of the support column part 12g on the one side in the axial direction. The pin part 71 faces at least one of the plurality of support column parts 12g with a gap therebetween when seen in the axial direction. That is, the pin part 71 is disposed close to at least one support column part 12g with a gap therebetween when seen in the axial direction. As the pin part 71 goes from the bottom wall part 17a to the one side in the axial direction, an outer diameter thereof gradually decreases. The pin part 71 includes a contact part 71a, a pedestal part 71b, and a pin rib part 71c.

The contact part 71a has a columnar shape which extends in the axial direction. In the embodiment, the contact part 71a has a cylindrical shape. The contact part 71a has a portion located at an end portion of the pin portion 71 on the one side in the axial direction. An outer peripheral surface of the contact part 71a is in contact with an inner peripheral surface of the positioning hole part 43 of the inverter substrate 40. An outer diameter of the pin part 71 is the smallest in a portion of the contact part 71a on the one side in the axial direction in which the pin rib part 71c is not disposed. In the pin part 71, the portion of the contact part 71a in which the pin rib part 71c is not disposed in the axial direction, that is, the portion of the contact part 71a on the one side in the axial direction may be rephrased as a small diameter portion of the pin part 71. The small diameter portion of the pin part 71 is inserted into the positioning hole part 43 of the inverter substrate 40.

The pedestal part 71b has a columnar shape which extends in the axial direction. In the embodiment, the pedestal part 71b has a cylindrical shape. The pedestal part 71b has an outer diameter larger than that of the contact part 71a. The pedestal part 71b is located on the other side of the contact part 71a in the axial direction. The pedestal part 71b is connected to an end portion of the contact part 71a on the other side in the axial direction. The pedestal part 71b supports the contact part 71a from the other side in the axial direction. That is, the pedestal part 71b supports the contact part 71a. The outer diameter of the pin part 71 is the largest in the pedestal part 71b. A portion of the pin part 71 in which the pedestal part 71b is disposed in the axial direction may be rephrased as a large diameter portion of the pin part 71. The outer diameter of the large diameter portion of the pin part 71 is larger than that of the small diameter portion of the pin part 71.

The pin rib part 71c has a rib shape which extends in the axial direction. The pin rib part 71c is provided on a portion of the outer peripheral surface of the contact part 71a located on the other side in the axial direction. The pin rib part 71c is not provided on a portion of the outer peripheral surface of the contact part 71a on the one side in the axial direction. An end portion of the pin rib part 71c on the one side in the axial direction is disposed on the other side in the axial direction from the plate surface of the inverter substrate 40 which faces the other side in the axial direction. That is, the pin rib part 71c and the inverter substrate 40 are disposed apart from each other in the axial direction. The end portion of the pin rib part 71c on the other side in the axial direction is connected to an end surface of the pedestal part 71b which faces the one side in the axial direction. As the pin rib part 71c goes toward the other side in the axial direction, a height thereof which protrudes from the outer peripheral surface of the contact part 71a increases.

A plurality of pin rib parts 71c is provided. The plurality of pin rib parts 71c is disposed on the outer peripheral surface of the contact part 71a to be spaced apart from each other when seen in the axial direction. A portion of the pin part 71 in which the pin rib part 71c is disposed in the axial direction may be rephrased as a medium diameter portion of the pin part 71. An outer diameter of the medium diameter portion of the pin part 71 is larger than that of the small diameter portion of the pin part 71 and is smaller than that of the large diameter portion of the pin part 71. The medium diameter portion and the large diameter portion of the pin part 71 are disposed on the other side in the axial direction from the inverter substrate 40.

The peripheral wall part 17b has a tubular shape which extends from an outer peripheral portion of the bottom wall part 17a to the one side in the axial direction. In the embodiment, the peripheral wall part 17b has a substantially polygonal tubular shape. The peripheral wall part 17b includes a spacer 17h and a connector part 17i.

The spacer 17h has a tubular shape which extends in the axial direction. In the embodiment, the spacer 17h has a cylindrical shape. The spacer 17h is provided on the peripheral wall part 17b and passes through the second member 17 in the axial direction. A plurality of spacers 17h is provided. The plurality of spacers 17h is disposed to be spaced apart from each other in the circumferential direction. Each of the fastening screws 18 is inserted into each of the spacers 17h. The spacers 17h are formed of a metal. When the second member 17 is injection-molded, the spacers 17h are disposed in a mold (not shown) together with another metal part. The second member 17 is insert-molded together with the spacers 17h by filling the mold with a molten resin and solidifying the molten resin.

The connector part 17i is connected to an external power source (not shown). The connector part 17i has a tubular shape. In the embodiment, the connector part 17i has a quadrangular tubular shape. The connector part 17i extends from the peripheral wall part 17b toward the outside of the peripheral wall part 17b when seen in the axial direction. The connector part 17i protrudes outward from the peripheral wall part 17b along a virtual plane (not shown) perpendicular to the central axis J. In the embodiment, a direction in which the connector part 17i protrudes from the peripheral wall part 17b may be referred to as a protruding direction. The protruding direction of the connector part 17i is the +X side. The side opposite to the protruding direction is the −X side. Further, a direction orthogonal to the protruding direction when seen in the axial direction may be referred to as a width direction. The width direction is the Y-axis direction. The connector part 17i is disposed at a position different from the central axis J in the width direction. In the width direction, a direction from the central axis J toward the connector part 17i is referred to as one side (the +Y side) in the width direction, and a direction from the connector part 17i toward the central axis J is referred to as the other side (the −Y side) in the width direction.

The connector part 17i and the peripheral wall part 17b are portions of a single member. A part of the wiring member 50 is disposed inside the connector part 17i. The connector part 17i is fixed to the wiring member 50.

The motor 20 includes a rotor 21, a stator 26, and the plurality of bearings 35 and 36. The rotor 21 includes a shaft 22, a rotor core 23, a magnet 24, and a magnet holder 2.

The shaft 22 extends along the central axis J. The shaft 22 extends in the axial direction about the central axis J. The shaft 22 rotates around the central axis J. The shaft 22 is supported by the plurality of bearings 35 and 36 to be rotatable around the central axis J. The plurality of bearings 35 and 36 is, for example, ball bearings or the like. The first bearing 35 of the plurality of bearings 35 and 36 supports a portion of the shaft 22 located on the other side in the axial direction from the rotor core 23. The second bearing 36 of the plurality of bearings 35 and 36 supports a portion of the shaft 22 located on the one side in the axial direction from the rotor core 23.

The rotor core 23 is fixed to an outer peripheral surface of the shaft 22. The rotor core 23 has an annular shape which extends in the circumferential direction around the central axis J. The rotor core 23 has a tubular shape which extends in the axial direction. The rotor core 23 is, for example, a steel plate stacked body configured by stacking a plurality of electromagnetic steel plates in the axial direction.

The magnet 24 is disposed on a radially outer surface of the rotor core 23. A plurality of magnets 24 is provided. The plurality of magnets 24 is disposed on the radial outer surface of the rotor core 23 to be spaced apart from each other in the circumferential direction. The magnets 24 may be, for example, a single cylindrical ring magnet.

The magnet holder 25 is provided on the rotor core 23 and holds the magnets 24. The magnet holder 25 fixes the magnets 24 to the rotor core 23. The magnet holder 25 is disposed on the radial outer surface of the rotor core 23 and a surface thereof which faces the other side in the axial direction. The magnet holder 25 presses the magnets 24 from the outer surface in the radial direction and the other side in the axial direction. The magnet holder 25 has a portion which is located between a pair of magnets 24 adjacent in the circumferential direction and extends in the axial direction, and a portion which has an annular shape centered on the central axis J and located on the other side of the magnet 24 in the axial direction.

The stator 26 is disposed on the outside of the rotor 21 in the radial direction and faces the rotor 21 with a gap therebetween in the radial direction. That is, the stator 26 faces the rotor 21 in the radial direction. The stator 26 surrounds the entire periphery of the rotor 21 in the circumferential direction from the outside in the radial direction. The stator 26 includes a stator core 27, an insulator 28, and a plurality of coils 29.

The stator core 27 has an annular shape centered on the central axis J. The stator core 27 surrounds the rotor 21 on the outside of the rotor 21 in the radial direction. The stator core 27 is disposed on the outside of the rotor 21 in the radial direction and faces the rotor 21 with a gap therebetween in the radial direction. The stator core 27 is, for example, a steel plate stacked body configured by stacking a plurality of electromagnetic steel plates in the axial direction.

The stator core 27 has a core back 27a and a plurality of teeth 27b. The core back 27a has an annular shape centered on the central axis. The core back 27a has a tubular shape which extends in the axial direction. An outer surface of the core back 27a in the radial direction is fixed to an inner peripheral surface of the accommodation tubular part 12a. The teeth 27b extend radially inward from an inner surface of the core back 27a in the radial direction. The plurality of teeth 27b is disposed on the inner surface of the core back 27a in the radial direction to be spaced apart from each other in the circumferential direction. Inner surfaces of the teeth 27b in the radial direction face radially outer surfaces of the magnets 24 with a gap therebetween from the outside in the radial direction.

The insulator 28 is mounted on the stator core 27. The insulator 28 has a portion which covers the plurality of teeth 27b. A material of the insulator 28 is an insulating material such as a resin, for example. The coils 29 are mounted on the stator core 27. The coils 29 are mounted on the stator core 27 via the insulator 28. The plurality of coils 29 is configured by winding a conductive wire around each of the teeth 27b via the insulator 28.

In the embodiment, the motor 20 is a three-phase motor. The three phases are a U phase, a V phase, and a W phase. In the case of the three-phase motor, the conductive wires constituting the U-phase, V-phase, and W-phase coils 29 are different from each other. That is, the conductive wire of the U-phase coil 29, the conductive wire of the V-phase coil 29, and the conductive wire of the W-phase coil 29 are different from each other. Each of the coils 29 has a pair of ends drawn from the coil 29 at both ends of the conductive wire of the coil 29. An end portion 29a of the conductive wire of the coil 29 may be rephrased as a lead-out portion of the coil 29.

The inverter substrate 40 is electrically connected to an external power source (not shown) via the wiring member 50. The inverter substrate 40 is electrically connected to the motor 20. The inverter substrate 40 supplies electric power supplied from an external power source to the stator 26 of the motor 20. The inverter substrate 40 controls a current supplied to the motor 20.

The inverter substrate 40 has a polygonal shape in the plan view of the inverter substrate 40 and has a plurality of corner portions 45a, 45b, . . . . In the embodiment, the inverter substrate 40 has a substantially pentagonal shape in the plan view of the inverter substrate 40, and the inverter substrate 40 has five corner portions 45a, 45b, . . . . In the embodiment, among the plurality of corner portions 45a, 45b, . . . , the corner portion located on the one side (the +Y side) in the width direction of the inverter substrate 40 and in the protruding direction (the +X side) in the plan view of the inverter substrate 40 is referred to as a first corner portion 45a. The first corner portion 45a is located on the one side (the +Y side) in the width direction from the central axis J and in the protruding direction (the +X side). Further, a second corner portion 45b is a corner portion located on the other side (the −Y side) in the width direction of the inverter substrate 40 and on the side (the −X side) opposite to the protruding direction in the plan view of the inverter substrate 40. The second corner portion 45b is located on the other side in the width direction and on the side opposite to the protruding direction from the central axis J. A third corner portion is located on the other side in the width direction and in the protruding direction from the central axis J in the plan view of the inverter substrate 40. A fourth corner portion and a fifth corner portion are located on the one side in the width direction and on the side opposite to the protruding direction from the central axis J in the plan view of the inverter substrate 40.

The inverter substrate 40 has a lead-out portion insertion hole 48, a terminal insertion hole 41, a screw insertion hole 42, and the positioning hole part 43. The lead-out portion insertion hole 48 passes through the inverter substrate 40 in a plate thickness direction thereof (in the axial direction). That is, the lead-out portion insertion hole 48 passes through the inverter substrate 40. A plurality of lead-out portion insertion holes 48 is provided. In the embodiment, the plurality of lead-out portion insertion holes 48 is disposed linearly in the plan view of the inverter substrate 40. The plurality of lead-out portion insertion holes 48 is disposed in an end portion of the inverter substrate 40 on the other side in the width direction and is arranged in the protruding direction. The end portions 29a of the coils 29 are respectively inserted into the lead-out portion insertion holes 48. Each of the end portions 29a of the coils 29 is joined to the inverter substrate 40 with a solder 30.

The terminal insertion hole 41 passes through the inverter substrate 40 in the plate thickness direction. That is, the terminal insertion hole 41 passes through the inverter substrate 40. A plurality of terminal insertion holes 41 is provided. In the embodiment, the plurality of terminal insertion holes 41 is disposed linearly in the plan view of the inverter substrate 40. The plurality of terminal insertion holes 41 is disposed at the end portion of the inverter substrate 40 in the protruding direction (the +X side) and is arranged in the width direction (the Y-axis direction). The terminal insertion holes 41 are disposed in the first corner portions 45a. In other words, among the plurality of corner portions 45a, 45b, . . . of the inverter substrate 40, the corner portion in which the terminal insertion hole 41 is located is the first corner portion 45a. Each of the terminal 51 of the wiring member 50 is inserted into each of the terminal insertion holes 41. The terminal 51 is joined to the inverter substrate 40 with the solder 31.

The screw insertion hole 42 passes through the inverter substrate 40 in the plate thickness direction. That is, the screw insertion hole 42 passes through the inverter substrate 40. The screw insertion hole 42 is disposed to overlap a female screw part of the support column part 12g in the plan view of the inverter substrate 40, that is, when seen in the axial direction. A plurality of screw insertion holes 42 is provided in the inverter substrate 40. When seen in the axial direction, each of the screw insertion holes 42 is disposed to overlap the female screw part of each of the support column parts 12g.

The screw insertion holes 42 are disposed in the plurality of corner portions 45a, 45b, . . . . At least one of the plurality of screw insertion holes 42 is disposed in the first corner portion 45a. In the embodiment, two screw insertion holes 42 are disposed in the first corner portion 45a. In the plan view of the inverter substrate 40, the terminal insertion hole 41 is disposed between the two screw insertion holes 42 of the first corner portion 45a. The terminal insertion hole 41 is located between the two screw insertion holes 42 in the width direction.

The positioning hole part 43 passes through the inverter substrate 40 in the plate thickness direction. That is, the positioning hole part 43 passes through the inverter substrate 40. In the embodiment, one positioning hole part 43 is provided in the inverter substrate 40. The positioning hole part 43 is disposed at a corner portion of the inverter substrate 40 in the plan view of the inverter substrate 40. The positioning hole part 43 is disposed in the first corner portion 45a. The positioning hole part 43 is disposed between the terminal insertion hole 41 and an outer peripheral end surface of the inverter substrate 40 in the plan view of the inverter substrate 40. In the embodiment, the positioning hole part 43 is disposed in the width direction between the terminal insertion hole 41 and the outer peripheral end surface of the inverter substrate 40 which faces the one side in the width direction.

The positioning hole part 43 faces one of the two screw insertion holes 42 of the first corner portion 45a which is located on the one side in the width direction from the terminal insertion hole 41 with a gap therebetween in the protruding direction in the plan view of the inverter substrate 40. That is, in the plan view of the inverter substrate 40, the screw insertion hole 42 of the first corner portion 45a and the positioning hole part 43 face each other with a gap therebetween.

The wiring member 50 extends over the outside and the inside of the second member 17 through the connector part 17i. That is, the wiring member 50 extends over the outside and the inside of the housing 11. The wiring member 50 is electrically connected to an external power source (not shown). The wiring member 50 is electrically connected to the inverter substrate 40. In the embodiment, the wiring member 50 is an elongated plate formed of a metal. The wiring member 50 may be rephrased as a bus bar. A plurality of wiring members 50 is provided.

The terminal 51 is provided at each of the wiring members 50. That is, a plurality of terminals 51 is provided. The terminal 51 is located at one of both end portions of the wiring member 50 which is disposed inside the housing 11. In the embodiment, the wiring member 50 is a single member, and the terminal 51 constitutes a part of the wiring member 50. The terminal 51 extends in the axial direction inside the inverter housing part 13. The terminal 51 is disposed at the first corner portion 45a of the inverter substrate 40 in the plan view of the inverter substrate 40. The terminal 51 is inserted into the terminal insertion hole 41. The terminal 51 is connected to the inverter substrate 40 using the solder 31.

The screw member 60 is inserted into the screw insertion hole 42. The screw member 60 has a male screw part. The male screw part of the screw member 60 inserted into the screw insertion hole 42 is screwed to a female screw part of the support column part 12g. That is, the screw member 60 is inserted into the screw insertion hole 42 and fixed to the support column part 12g. The screw member 60 fixes the inverter substrate 40 to the housing 11.

The substrate positioning structure 70 positions the inverter substrate 40 with respect to the housing 11. In the embodiment, the substrate positioning structure 70 includes the pin part 71 and a positioning part of the inverter substrate 40 with which an outer peripheral surface of the pin part 71 is in contact. Specifically, the contact part 71a of the pin part 71 is in contact with the positioning part of the inverter substrate 40. In the embodiment, the positioning part of the inverter substrate 40 is the inner peripheral surface of the positioning hole part 43. That is, an outer peripheral surface of the contact part 71a is in contact with the inner peripheral surface of the positioning hole part 43.

According to the embodiment, the inverter substrate 40 can be fixed to the housing 11 with the screw member 60 in a state in which the inverter substrate 40 is positioned with respect to the housing 11 by the substrate positioning structure 70. Thus, the rotation of the inverter substrate 40 together with the screw member 60 can be curbed, and a load applied to the terminal 51 or the solder 31 can be curbed. Further, according to the embodiment, the inverter substrate 40 can be positioned with respect to the housing 11 with a simple configuration in which the outer peripheral surface of the pin part 71 is brought into contact with the positioning part of the inverter substrate 40.

Further, according to the embodiment, the entire periphery of the outer peripheral surface of the pin part 71 is surrounded by the inner peripheral surface of the positioning hole part 43. Therefore, the inverter substrate 40 is stably positioned with respect to the housing 11 in all directions along a virtual plane (not shown) perpendicular to the central axis J. Furthermore, according to the embodiment, rigidity of the pin part 71 can be ensured by the pedestal part 71b and the pin rib part 71c while the outer diameter of the contact part 71a of the pin part 71 is minimized and a degree of freedom of a wiring pattern of the inverter substrate 40 is enhanced, and the inverter substrate 40 can be positioned stably.

The substrate positioning structure 70 is disposed at the first corner portion 45a of the inverter substrate 40. According to the embodiment, since the substrate positioning structure 70 and the terminal insertion hole 41 can be disposed close to each other, the terminal 51 can be easily inserted into the terminal insertion hole 41 while the substrate positioning structure 70 functions stably.

The substrate positioning structure 70 is disposed between the terminal insertion hole 41 and the outer peripheral end surface of the inverter substrate 40 in the plan view of the inverter substrate 40. In the embodiment, the substrate positioning structure 70 is disposed in the width direction between the terminal insertion hole 41 and the outer peripheral end surface of the inverter substrate 40 which faces the one side in the width direction. According to the embodiment, since the substrate positioning structure 70 is disposed close to the outer peripheral end surface of the inverter substrate 40, it is possible to curb an influence of the substrate positioning structure 70 on the degree of freedom of the wiring pattern of the inverter substrate 40.

In the plan view of the inverter substrate 40, the substrate positioning structure 70 faces one of the two screw insertion holes 42 of the first corner portion 45a, which is located on the one side in the width direction from the terminal insertion hole 41, with a gap therebetween in the protruding direction. That is, in the plan view of the inverter substrate 40, the screw insertion hole 42 of the first corner portion 45a and the substrate positioning structure 70 face each other with a gap therebetween. According to the embodiment, in the first corner portion 45a, the screw insertion hole 42 and the substrate positioning structure 70 are disposed close to each other with a gap therebetween. Since the wiring pattern of the inverter substrate 40 is difficult to be disposed close to the screw insertion hole 42, the degree of freedom of the wiring pattern is maintained well even when the substrate positioning structure 70 is disposed.

Moreover, in this embodiment, the screw insertion hole 42 is disposed in the plurality of corner portion 45a, 45b, . . . of the inverter substrate 40. According to the embodiment, since the inverter substrate 40 is fixed with the screw members 60 of the plurality of corner portions 45a, 45b, . . . , a fixed state of the inverter substrate 40 is more stable.

The coil support 80 is located between the motor 20 and the inverter substrate 40 in the axial direction. That is, the coil support 80 is disposed between the motor 20 and the inverter substrate 40. The coil support 80 supports the end portion 29a of the coil 29 between the motor 20 and the inverter substrate 40. The coil support 80 guides the end portion 29a of the coil 29 toward the inverter substrate 40 in the axial direction.

The pump part 90 is driven by the power of the motor 20. The pump part 90 suctions and discharges a fluid such as oil. The pump part 90 is disposed on the other side of the motor 20 in the axial direction. The pump part 90 is located at a portion of the electric pump device 1 on the other side in the axial direction. Although not particularly shown, the pump part 90 is connected to a flow path of the fluid such as oil provided in a driving device of a vehicle, or the like. Accordingly, the portion of the electric pump device 1 on the other side in the axial direction at which the pump part 90 is located is fixed to a member of a vehicle.

In the embodiment, the pump part 90 has a trochoid pump structure. The pump part 90 includes an inner rotor 91 and an outer rotor 92. Each of the inner rotor 91 and the outer rotor 92 has a trochoidal tooth profile. The inner rotor 91 is fixed to an end portion of the shaft 22 on the other side in the axial direction. Relative rotation of the inner rotor 91 and the shaft 22 around the central axis J may be allowed within a predetermined range. The outer rotor 92 is disposed on the outside of the inner rotor 91 in the radial direction. The outer rotor 92 surrounds the inner rotor 91 from the radially outside over the entire periphery in the circumferential direction.

The pump cover 95 is fixed to an end portion of the motor housing part 12 on the other side in the axial direction and covers the pump part 90 from the other side in the axial direction. That is, the pump cover 95 is fixed to the housing 11 and covers the pump part 90. The pump cover 95 is fixed to a member (not shown) of a vehicle. A surface of the pump cover 95 which faces the other side in the axial direction is in contact with the member of the vehicle. The pump cover 95 has a cover part 96 and a leg part 97.

The cover part 96 is disposed to overlap the pump part 90 when seen in the axial direction and covers the pump part 90 from the other side in the axial direction. That is, the cover part 96 covers the pump part 90. The cover part 96 has an inflow port 96a and an outflow port 96b. The inflow port 96a and the outflow port 96b are connected to the pump part 90. The inflow port 96a is configured by a through hole which passes through the cover part 96 in the axial direction. The inflow port 96a allows a fluid to flow into the pump part 90. That is, the pump part 90 suctions the fluid from the outside of the device through the inflow port 96a. The outflow port 96b is configured by a through hole which passes through the cover part 96 in the axial direction. The outflow port 96b allows the fluid to flow out from the pump part 90. That is, the pump part 90 discharges the fluid to the outside of the device through the outflow port 96b. In the embodiment, the inflow port 96a and the outflow port 96b are arranged in the protruding direction when seen in the axial direction.

The leg part 97 is connected to the cover part 96 and is disposed on the outside of the cover part 96 in the radial direction. The leg part 97 protrudes radially outward further than the accommodation tubular part 12a. A plurality of leg parts 97 is provided to be arranged in the circumferential direction. A bolt insertion hole 97a is provided at a radially outer end portion of each of the leg parts 97. The bolt insertion hole 97a passes through the leg part 97 in the axial direction. The electric pump device 1 is fixed to the member of the vehicle using a bolt member (not shown) inserted into the bolt insertion hole 97a.

The disclosure is not limited to the above-described embodiment. For example, as described below, the configuration can be changed without departing from the spirit of the disclosure.

In the above-described embodiment, the configuration in which the screw member 60 fixes the inverter substrate 40 to the housing 11 has been described as an example. However, the disclosure is not limited thereto. A configuration in which the screw member 60 fixes the inverter substrate 40 to an element (for example, the insulator 28 or the like) of the motor 20 may be adopted. That is, the screw member 60 fixes the inverter substrate 40 to the housing 11 or the motor 20.

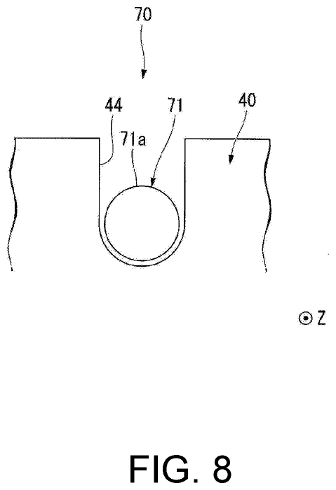

In the above-described embodiment, an example in which the positioning part of the inverter substrate 40 in the substrate positioning structure 70 is the inner peripheral surface of the positioning hole part 43 has been described, but the disclosure is not limited thereto. FIG. 8 shows a modified example of the substrate positioning structure 70. In the modified example, the positioning part of the inverter substrate 40 is an inner peripheral surface of a positioning concave part 44 which is recessed from the outer peripheral end surface of the inverter substrate 40. According to the modified example, when the inverter substrate 40 is assembled to the housing 11, the pin part 71 can be easily set in the positioning concave part 44, and the manufacturing is easy.

Also, as a modified example different from the above-described one, although not particularly shown, the substrate positioning structure 70 may include a hole part provided in the inverter housing part 13, and a positioning part of the inverter substrate 40 which overlaps the hole part in the plan view of the inverter substrate 40. For example, the hole part is recessed from the plate surface of the bottom wall part 17a facing the one side in the axial direction to the other side in the axial direction and faces the inverter substrate 40 from the other side in the axial direction. The positioning part of the inverter substrate 40 is one of the positioning hole part 43 which passes through the inverter substrate 40 and the positioning concave part 44 which is recessed from the outer peripheral end surface of the inverter substrate 40. According to the modified example, a jig pin (not shown) may be inserted into the hole part, and an outer peripheral surface of the jig pin may be brought into contact with one of the inner peripheral surface of the positioning hole part 43 of the inverter substrate 40 and the inner peripheral surface of the positioning concave part 44. The inverter substrate 40 can be positioned with respect to the housing 11 with a simple configuration.

In the above-described embodiment, the protruding direction and the width direction are defined in the direction along a virtual plane (not shown) perpendicular to the central axis J, but the disclosure is not limited thereto. For example, a direction parallel to the protruding direction may be referred to as a “first direction” regardless of the direction in which the connector part 17i protrudes from the peripheral wall part 17b. That is, the first direction is a predetermined direction among the directions along a virtual plane perpendicular to the central axis J. In this case, one side (the +X side) in the first direction corresponds to the protruding direction, and the other side (the −X side) in the first direction corresponds to the side opposite to the protruding direction. Further, the width direction may be rephrased as the “second direction.” That is, the second direction is a direction orthogonal to the first direction among the directions along a virtual plane perpendicular to the central axis J. In this case, one side (the +Y side) in the second direction corresponds to the one side in the width direction, and the other side (the −Y side) in the second direction corresponds to the other side in the width direction.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A motor unit, comprising:
a motor;
an inverter substrate electrically connected to the motor;
a housing configured to accommodate the motor and the inverter substrate;
a terminal located at an end portion of a wiring member which extends over an outside and an inside of the housing, and inserted into a terminal insertion hole which passes through the inverter substrate;
a screw member inserted into a screw insertion hole which passes through the inverter substrate and configured to fix the inverter substrate to the housing or the motor; and
a substrate positioning structure configured to position the inverter substrate with respect to the housing.

2. The motor unit according to claim 1, wherein;
the housing includes a motor housing part configured to accommodate the motor, and an inverter housing part configured to accommodate the inverter substrate, and
the substrate positioning structure includes a pin part provided at the inverter housing part, and a positioning part of the inverter substrate configured to be in contact with an outer peripheral surface of the pin part.

3. The motor unit according to claim 2, wherein the positioning part is an inner peripheral surface of a positioning hole part which passes through the inverter substrate.

4. The motor unit according to claim 2, wherein the positioning part is an inner peripheral end surface of a positioning concave part which is recessed from an outer peripheral end surface of the inverter substrate.

5. The motor unit according to claim 2, wherein the pin part includes a contact part configured to be in contact with the positioning part, and a pedestal portion having an outer diameter larger than that of the contact part and configured to support the contact part.

6. The motor unit according to claim 1, wherein;
the housing includes a motor housing part configured to accommodate the motor, and an inverter housing part configured to accommodate the inverter substrate,
the substrate positioning structure includes a hole part provided at the inverter housing part, and a positioning part of the inverter substrate configured to overlap the hole part in a plan view of the inverter substrate, and
the positioning part is one of a positioning hole part configured to pass through the inverter substrate or a positioning concave part recessed from an outer peripheral end surface of the inverter substrate.

7. The motor unit according to claim 1, wherein:
the inverter substrate has a polygonal shape in a plan view of the inverter substrate and has a plurality of corner portions; and
the substrate positioning structure is disposed at a first corner portion among the plurality of corner portions in which the terminal insertion hole is located.

8. The motor unit according to claim 7, wherein the substrate positioning structure is disposed between the terminal insertion hole and the outer peripheral end surface of the inverter substrate in the plan view of the inverter substrate.

9. The motor unit according to claim 7, wherein:
a plurality of the screw insertion holes are provided in the inverter substrate;
at least one of the plurality of screw insertion holes is disposed at the first corner portion, and
the screw insertion hole in the first corner portion and the substrate positioning structure face each other with a gap therebetween in the plan view of the inverter substrate.

10. An electric pump device comprising:
the motor unit according to claim 1.
